(19) United States
(12) Patent Application Publication
(10) Pub. No.: US 2006/0143022 A1
(43) Pub. Date: Jun. 29, 2006

(54) Consumer care management method and system

(76) Inventors: Betty Bird, Nyack, NY (US); Patrick J. Benson, New York, NY (US); Tana D'Allura, South Sterling, PA (US); Josephine Defini, New York, NY (US); Michael Fischer, Hyde Park, NY (US); Joseph R. Laurenzano, Berkeley Heights, NJ (US); Edward Martinez, Maplewood, NJ (US); Nancy C. Paskin, Mohegan Lake, NY (US); Martin S. Yablonski, Golden Bridge, NY (US)

Correspondence Address: MARC E. HANKIN, ESQ., 11414 THURSTON CIRCLE, LOS ANGELES, CA, 90049, US

(21) Appl. No.: 10/542,037

(22) PCT Filed: Jan. 13, 2004
(86) PCT No.: PCT/US04/00838

§ 371 Date: Jul. 13, 2005

(51) Int. Cl. G06Q 99/00

(52) U.S. Cl. 705/1

(57) ABSTRACT

In the consumer care management system and method of the present invention, a system and method is provided for evaluating the needs of the visually impaired as well as providing a uniform service quality to the consumer through uniform assessments and analyses regardless of the extent of the consumer's impairment. Several series of standardized questions are asked which assess the needs of the consumer. To evaluate every consumer equally regardless of the locale of the consumer seeks assistance; the system is divided into several different uniform processes. The answers to the standardized questions during the processes determine the extent of help the consumer requires. The processes that the consumer will go through include registration and crisis identification, triage, payment, assessment, incremental record of activity, outcomes and quality assurance.

### FIELD OF THE INVENTION

The present invention relates generally to managing services and resources for consumers with medical conditions.

### BACKGROUND OF THE INVENTION

With the advancement of medicine and medical technology, people are living much longer lives. As a result of living longer, people are afflicted with more and more medical problems which require assessment and delivery of appropriate rehabilitation services. Currently, there is no uniform method for assessing a visually impaired person's medical problems and determining which treatment and/or rehabilitation services are appropriate for those problems.

Specifically, for example, the number of people that require vision rehabilitation services is growing exponentially as people live longer. Not only do individuals with no functional vision require a variety of vision rehabilitation services, but those with partial sight and those with deteriorating vision also require vision rehabilitation services. To assess a person with a degree of sight impairment, several components are required. These components include a specialized functional vision eye exam to determine the extent of vision loss commonly called a low vision exam, the prescription of and training in the use of optical and non-optical devices to help maximize remaining vision and services to restore independent and productive living (such as orientation and mobility (safe travel) skills, adjustment to vision loss, employment and computer skills personal grooming, cooking safely, etc.). These components need to be assessed, monitored, and adjusted according to a uniform method of delivery. The vision rehabilitation field has never developed such a method of delivery. Furthermore, there has been no way to track concretely the success of various vision rehabilitation therapies, collect a repository of data and follow a trajectory for the individual or consumer who is receiving the services. As such, there is a need for a standardized method to manage resources for consumers with visual impairment.

Moreover, the delivery of modern medicine and health care rehabilitation services increasingly have grown automated. There is a need a need to automate protocol to make them more efficient, more uniform, and easily to distribute, implement and provide training.

### SUMMARY OF THE INVENTION

It is an advantage of the present invention to provide a method and system to manage services and resources and document functional change for consumers with visual impairment.

It is another advantage of the present invention to provide a method and system to implement consistent protocols in assessing needs and recommending training for consumers with visual impairment.

It is a further advantage of the present invention to provide a method and system to measure and report the progress of the consumers.

It is yet another advantage of the present invention to standardize service quality through uniform assessments and analyses.

It is yet another advantage of the present invention to provide a service plan based on each consumer's functional goals.

It is yet another advantage of the present invention to provide a method and system for providing a quality assessment of the training of the consumers.

In the consumer care management method and system of the present invention, a method and system is provided for evaluating the functional training needs of the visually impaired as well as providing a standardized service quality to the consumer through uniform assessments and analyses regardless of the extent of the consumer's impairment. To provide such a standardized quality of service to all consumers, several series of uniform questions are asked which assess the functional needs of the consumer. As every consumer is asked the same questions and the answers to the questions determine the service needs of the consumer, the needs of the consumer are evaluated on a is standard scale and uniform questions allow numerical scores to be generated. To evaluate every consumer, regardless of the locale where the consumer seeks assistance with the system of the present invention, the system is divided into several different uniform steps or processes. The answers to the standardized questions during the processes determine the extent of help the consumer requires, including the: type of help required, as well as the number of hours of assistance that the consumer will require to achieve agreed upon goals. The processes that the consumer will go through include registration and crisis identification, triage problem identification, assessment development of goals and objectives and pre-service score incremental record of activity progress report outcome determination, and post service score and quality assurance, and satisfaction surveys.

During the registration process, basic demographics such as the name and address of the consumer are collected by a staff member of the service provider. The staff member also asks a series of standardized questions to determine what services the visually impaired consumer requires. After the consumer has answered the series of uniform questions for registration, the staff member schedules an appointment for the triage process for the consumer to identify functional problems caused by vision loss. The triage process also identifies the consumer's problems and schedules the consumer for appointment(s) or for additional assessments, including a low vision assessment if appropriate. Answers to the questions during the triage process prompt assessment recommendations for the consumer which the consumer can either accept or reject.

During the assessment process, an assessor for each intervention recommended asks a series of uniform self assessment questions to assess the extent of the problems of the consumer identified during the triage process. In addition to asking questions, the assessor has the consumer perform tasks so that the consumer can demonstrate his or her current ability, skill and safety in performing the tasks. The assessor observes the consumer performing the tasks and rates the consumer at these tasks. The ratings identify any interventions that the consumer requires to improve the problems identified. Interventions are programs or services offered by the service provider to address the problems of the consumer and make a plan and set goals to help the consumer-achieve functional improvement and increased safety with the identified problems. The assessment also includes, identifying the effects of any field restrictions, identifying any concomitant medical conditions, and identifying any medications the consumer is taking. Numerous assessments available to the consumer include independent living, psychotherapy, orientation and mobility, low vision, computer training, employment services, and social services.

After the assessments are completed and the consumer and the assessor have agreed upon a training plan, which is a set of goals to achieve in a set time frame, the assessor will meet with the consumer to work on these goals. The assessor will numerically record the findings from the training into an Incremental Record of Activity (IRA). This record identifies the progress the consumer is making throughout training. Once training is completed, the assessor will fill out a final IRA which will close the particular intervention for the consumer with a computer generated outcome. In the final IRA, the pre service score assessment score, as well as a post service score, will be identified so progress can be documented.

After completion of all interventions and final IRAs, the consumer is asked to fill out a satisfaction questionnaire. The questions address the consumer's experience and the answers are utilized to determine the quality of the process and for process improvement. Six months after completion of all interventions and final IRAs, a post-service follow up is conducted and the satisfaction questionnaire is repeated. Additionally, the post-service follow up also finds out how the consumer has been doing since training has been completed. The answers from these questionnaires are tabulated into quality assurance scores and consumer satisfaction scores. The scores are utilized to provide corrective action and to determine if the services provided are valuable. Finally, the data is collected during the process including consumer demographics, intervention types, goals, objectives and the success rate of the interventions. The collected data can then be utilized for such things as cost benefit analysis to determine if the cost of the treatment plans is less than the cost of health care when the consumer has not been treated. Substantial collection of this data will permit the development of benchmarks for quality and performance in vision rehabilitation.

The foregoing, together with other features and advantages of the present invention, will become more apparent when referring to the specification, claims, and accompanying drawings.

### BRIEF DESCRIPTION OF THE DRAWINGS

The present invention will be better understood from the following detailed description of an exemplary embodiment of the invention, taken in conjunction with the accompanying drawings in which like reference numerals refer to like parts and in which:

FIG. 1 is a flow chart of the operation of an exemplary system for evaluating medical conditions, of consumers by asking a series of uniform questions which determine a treatment plan for vision rehabilitation services required by the consumer;

FIG. 2 illustrates a screen image from the registration process in accordance with an exemplary embodiment of the present invention;

FIG. 3 illustrates a first screen image from the triage process in accordance with an exemplary embodiment of the present invention;

FIG. 4 illustrates a second screen image from the triage process which generates intervention recommendations based upon the consumer's response to problem identification questions, in accordance with an exemplary embodiment of the present invention;

FIG. 5 illustrates a recommended assessment screen image from the triage process, which identifies recommended assessments for the consumer, in accordance with an exemplary embodiment of the present invention;

FIG. 6 illustrates a closure screen image from the triage process, which closes out the triage process of the system, in accordance with an exemplary embodiment of the present invention;

FIG. 7 illustrates a visual and health information screen image in accordance with an exemplary embodiment of the present invention;

FIG. 8 illustrates a payer screen image in accordance with an exemplary embodiment of the present invention;

FIG. 9 illustrates an independent living assessment screen image in accordance with an exemplary embodiment of the present invention;

FIG. 10 illustrates a social service assessment screen image in accordance with an exemplary embodiment of the present invention;

FIG. 11 illustrates the goal information and objective sections of an interim record of activity screen image in accordance with an exemplary embodiment of the present invention;

FIG. 12 illustrates an intervention screen image in accordance with an exemplary embodiment of the present invention;

FIG. 13 illustrates an ending an episode of service image screen in accordance with an exemplary embodiment of the present invention;

FIG. 14 illustrates a quality assurance screen image in accordance with an exemplary embodiment of the present invention; and

FIG. 15 illustrates a flow chart showing the overall method of providing a treatment plan for a consumer, through the process of assessment only as described in greater detail above.

### DETAILED DESCRIPTION OF THE DRAWINGS

An exemplary embodiment of the consumer management system of the present invention provides a method and system for assessing and determining consumer's problems according to consistent protocols or a standard of service delivery in the vision rehabilitation field. The consistent protocols are utilized to determine a treatment plan for the consumer's identified and functional problems. The system allows the success of the treatment plan to be tracked, the data from the treatment plan collected and the consumer's progress documented. Although the present invention is described in relation to the vision rehabilitation field in the exemplary embodiment, those skilled in the art will recognize that the principles and teachings described herein may be applied to a variety of applications and services in the medical industry.

The consumer care management system of the present invention provides a method and system for evaluating the needs of the individuals who are visually impaired and providing uniform service quality to the consumer through uniform assessments and analyses regardless of the extent of the consumer's impairment. To provide such a standardized quality of service to all consumers, several series of uniform questions are asked which assess the functional needs of the consumer. As every consumer is asked the same questions and the answers to the questions determine the service level of the consumer, the needs of the consumer are evaluated on a standardized scale. To evaluate every consumer, regardless of the locale where the consumer seeks assistance with the system of the present invention, the system is divided into several different standardized steps or processes. The answers to the uniform questions during the processes determine the extent of help that normally should be required by such a consumer, including the treatment plan which includes duration and intensity of training that the consumer will require to achieve consumer agreed upon goals. The processes that the consumer will go through include registration, triage, assessment, training, incremental record of activity, and quality assurance. Each of these processes will be discussed in detail below.

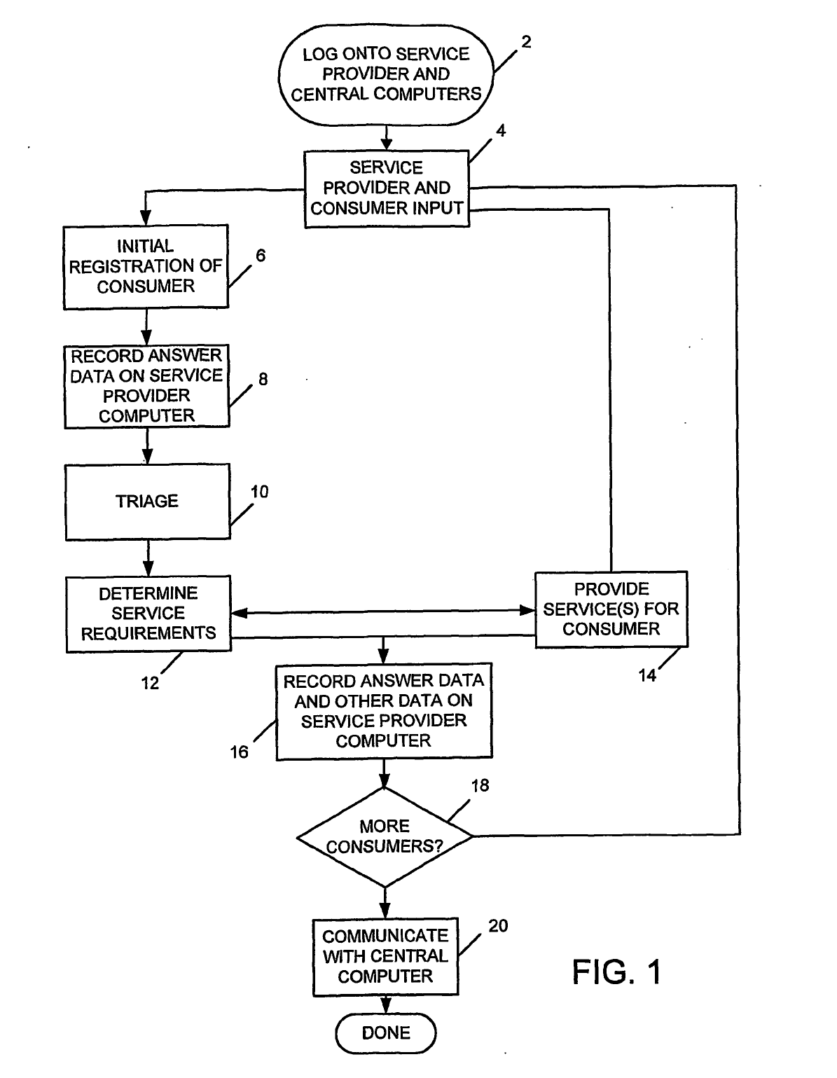

The system is utilized by service providers assisting the visually impaired. Service providers include hospitals, doctors, governments, organizations, etc. Staff members of the service provider ask the uniform series of questions to the consumer. Turning to FIG. 1, the fundamental operation of an exemplary system for evaluating medical conditions, specifically vision impairment, of consumers and determining any vision rehabilitation services required by the consumer is illustrated. The method begins when a staff member logs onto the central computers to access the system 2. Once logged on, the staff member meets with a consumer 4 to register the consumer in the system 6 and determine if the consumer is in need of any of the vision rehabilitation services that are offered by the service provider. During the registration process, the staff member obtains the name and address of the consumer so that a search of the service provider's database can be performed to locate any previous episodes the consumer completed. An episode is a treatment plan the consumer has with the service provider. If the consumer already has an open episode within the system, the staff member retrieves the episode and opens up a new file within the episode. If the consumer has no prior episodes in the system, an episode is created by registering the consumer.

When registering a consumer, the staff member asks a series of uniform questions which are then recorded into the system 8. The first question asked is whether the consumer is having vision problems followed by what the biggest problem or concern the consumer has related to vision, such as difficulty reading, difficulty walking across the room, etc. Based upon the answers to these questions, the system determines whether the consumer should continue through to triage 10 to identify specific problems of functioning. Triage 10 is comprised of another series of uniform questions that based on the consumer' answers, will determine which assessments/services might be recommended based on the consumer's needs. The uniform questions identify the consumer's vision status, health status and identify their functional problems, and then appointments are scheduled to assess the exact needs of the consumer 12 so the necessary services may be provided for the consumer 14. Skip patterns for the uniform questions are imbedded within the system so that only relevant questions are asked of the consumer. The answers to these questions, as well as the registration information, are then saved. 16. Once the staff member has recorded all the data from the consumer and the consumer is not in need of assistance or has been sent on to triage, each consumer's record is saved into the central database by each worker as each finishes their work for that consumer for that session. The processes of the registration section of the consumer care management system are then complete. The staff member assists additional consumers that may need assistance 18.

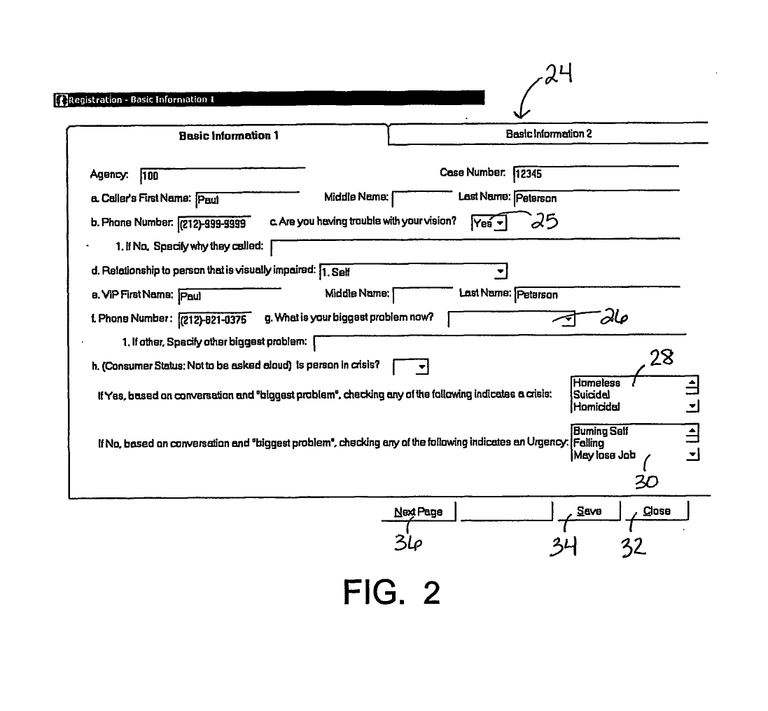

Although the present invention is described utilizing a series of screen images, those skilled in the art will recognize that the principles and teaching described herein may be utilized by manually recording the consumer's answers to questions and manually calculating the consumer's assessment scores. Furthermore, the method and system of the present invention is accessible to blind and partially sighted customers by providing the ability to use either JAWS™ for speech output or Zoomtext™ for screen magnifications. As mentioned previously, the first process for providing services for the visually impaired is registration. FIG. 2 illustrates a screen image 24 from the registration process of an exemplary embodiment of the present invention. As discussed previously, a staff member utilizing the system obtains basic information from the consumer seeking help, including the consumer's name and phone number. The staff member also asks whether the consumer is having trouble with vision and enters the answer into window 25 which includes a drop down box containing the two possible answers, yes or no. If the answer is no, registration follows a unique path by selecting the close button 32 and the staff member inquires into why the individual has sought assistance. If the answer is yes, the staff member proceeds on. with the registration process Next, the staff member asks what currently is the consumer's biggest problem related to vision and records the answer into window 26, which includes a drop down box containing a list of potential problems of the consumer. Registration illustrates the beginning of the process where a vision problem is first identified. Next, the biggest functional or life problem due to the vision loss is identified. Using the structured registration and then the triage functional interview, staff with modest training can gather the information required to then send the consumer to certified specialists for detailed assessment and treatment planning. The protocols specify the certified specialists required for each domain (problem areas within the intervention) of deficiencies or needs. The protocols mandate consumer response; either acceptance or rejection of the goals in the treatment plan.

After a determination has been made that the consumer has a problem associated with vision, the biggest problem resulting from said consumer's vision is identified and it is determined whether or not the consumer is in a crisis situation, requires urgent attention or will follow the normal course of service. The method specifically defines “crisis” and “urgent” so specific sequences of intervention can be followed. Window 28 indicates examples of problems the consumer may have which would indicate a crisis, such as the consumer is homeless, suicidal, homicidal, etc., caused by her or her vision problems. If any of the problems are selected, the consumer is determined to be in crisis and requires immediate professional attention. If a consumer is not in crisis, the staff member next determines if the consumer has an urgent problem. Window 30 indicates examples of problems the consumer may have which indicate an urgency, such as the consumer may burn self, may fall, may lose job, etc. due to vision problems. If any of the problems are selected, the consumer is in an urgent situation and requires attention. After the information has been recorded, the staff member selects the save button 24 at the bottom of the screen to record the information in the computer. Additionally, the information may be saved after the completion of the process.

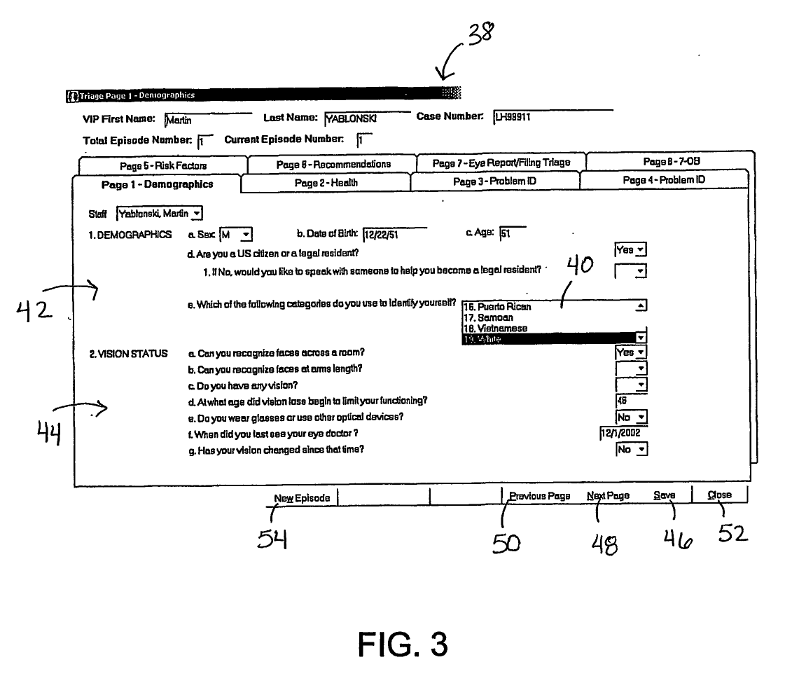

To continue on with the process, the staff member selects the next page button 36 at the bottom of screen 24. Upon selecting the next page button 36, a first screen image 38 from the triage process, in accordance with an exemplary embodiment of the present invention, is displayed. See FIG. 3. As discussed previously, triage comprises a series of uniform, sequenced questions the answers of which will determine which assessments/services will be recommended to the consumer. Such services include psychotherapy, computer training, employment services, help with living independently, help with improving mobility and help with low or poor vision. During the triage phase, the uniform questions asked by the staff member enable the consumer's problems to be quickly identified. First, the staff member asks a series of uniform questions about the demographics of the consumer 42. The consumer's answers are recorded into the appropriate window in screen 38 and then the ethnicity of the consumer is selected from window 40. The demographics of the consumer enable the service provider to properly schedule the assessments/services needed by the consumer.

Next, the staff member asks a series of functional questions about the vision status 44 of the consumer. Examples of these questions include: (1) Can the consumer recognize faces across a room? (2) Can the consumer recognize faces at arms length? and (3) At what age did the consumer's vision loss begin to limit the consumer's functioning? The answers to these questions dictate the sequence of following questions. The responses are then recorded into the corresponding window, some of which contain drop down boxes, on the first image screen 38. After all the information has been recorded on the first image screen 38 of the triage phase, the staff member selects the save button 46 which then saves all the consumer's information. After saving the information, the staff member selects the next page button 48 at the bottom of the first image screen 38. Alternatively, the staff member may select the previous page button 50 to alter information on the previous screen, the close button 52 to end the episode or the new episode button 54 to begin the process over with a different consumer. Additionally, the information may be saved after the completion of the process.

Upon selecting the next page button 48, the next screen image from the triage process is displayed. This screen, not shown, prompts the staff member to ask another series of required questions about the health status of the consumer. Examples of these questions include:

(1) Does the consumer have diabetes?

(2) Does the consumer have health conditions that limit activities? and

(3) Does the consumer have trouble seeing a TV, computer screen, or street sign?

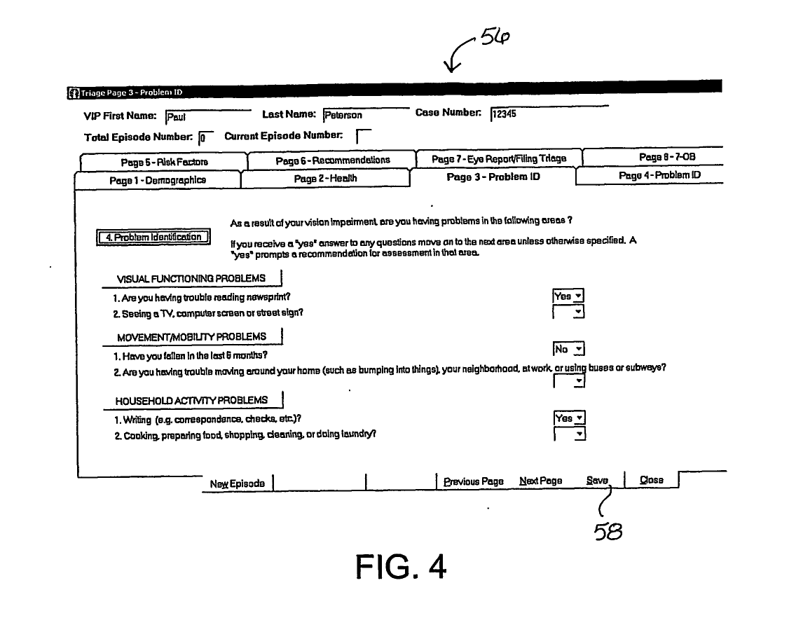

Once information about the consumer's health status has been recorded, coupled with information collected earlier that the consumer has been determined to have vision impairment, the staff member asks yet another series of uniform questions to identify the “domain” of the consumer's functional problems or deficiencies. FIG. 4 illustrates a problem identification screen image 56 from the triage process which generates assessment recommendations based upon the consumer's self assessment to vision and health status as well as problem identification, in accordance with an exemplary embodiment of the present invention. An intervention is a program or service offered to the consumer to address the consumer's rehabilitation/medical needs. Services include psychotherapy, adjustment to vision loss, computer training, employment services, help with living independently, social service, help with improving mobility and help with low or poor vision.

In the problem identification screen image 56, the staff member is prompted to ask a series of questions related to such areas as visual functioning, movement/mobility and household activities to identify functional problems. To determine if the consumer has visual functioning problems, the staff member asks specific functional questions related to safety, self-reliance, and mental health, such as (1) Is the consumer having trouble reading newsprint? and (2) Is the consumer having trouble seeing a TV, computer screen, or street sign? To determine if the consumer has movement/mobility problems, the staff member asks targeted, specific questions related to movement/mobility problems, such as (1) Has the consumer fallen in the last six months? and (2) Is the consumer having trouble moving around the home, neighborhood, at work or using buses, or the subway? To determine if the consumer has household activity problems, the staff member asks specific functional questions related to household activity problems; such as (1) Does the consumer have problems writing? and (2) Does the consumer have problems cooking, preparing food, shopping, cleaning, or doing laundry? The answers to these questions are then entered into the corresponding window on the problem identification screen image 56. After all the information has been recorded on the problem identification screen image 56 of the triage phase, the staff member selects the save button 58 which then saves all the consumer's information. Additionally, the information may be saved after the completion of the process.

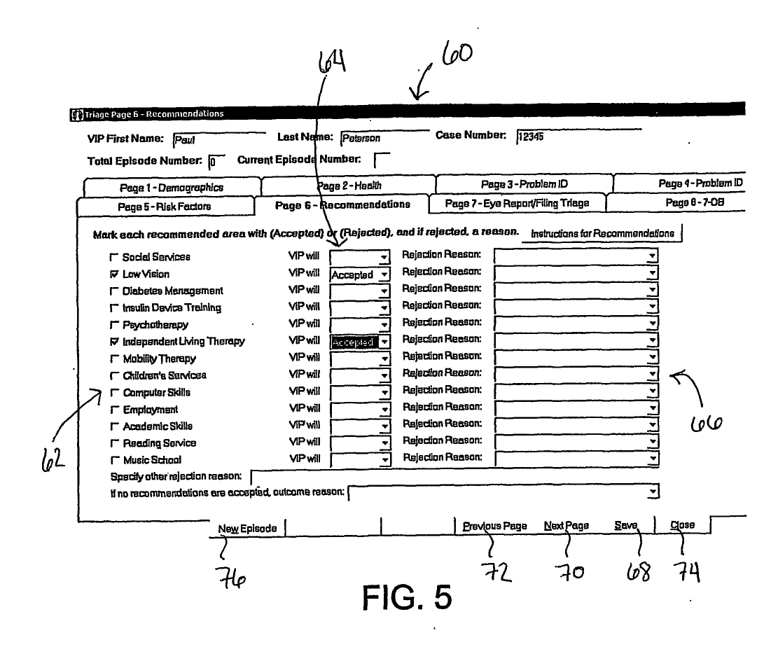

It should be noted that not all of the questions have to be asked of all consumers. If an answer to a question triggers a recommendation for a particular intervention to a problem, the system will skip all remaining questions that would trigger that same intervention. The problem identification screen image 56 is shown by way of example only. The staff member will be directed to additional screen images (not shown here) in the triage phase to identify all vision related functional problems. Once all the problems have been identified, a recommended assessment screen image 60 from the triage process, which identifies recommended assessments/interventions for the consumer, in accordance with an exemplary embodiment of the present invention, is displayed. See FIG. 5. The recommended assessment/interventions screen image 60 is comprised of possible assessments/interventions 62 available to the consumer. These interventions include low vision, psychotherapy, independent living therapy, computer skills, etc. Based upon the consumer's answers to previous questions, the interventions recommended to the consumer are automatically identified. As is illustrated in FIG. 5, the low vision and independent living therapy interventions are recommended to the consumer. The consumer must now either accept or reject each recommended intervention. Once the consumer has made a decision about each intervention, that decision is selected by utilizing the drop down box associated with a window corresponding to each recommendation 64. The drop down box directs the staff member to record either “accepted” or “rejected” into each corresponding window. If the consumer rejects an intervention, the recommended interventions screen image 60 also contains window 66 for identifying the reason the consumer rejected the intervention. After all the information has been recorded on the recommended interventions screen image 60 of the triage phase, the staff member selects the save button 68 which then saves all the consumer's information. After saving the information, the staff member selects the next page button 70 at the bottom of the recommended interventions screen image 60. Alternatively, the staff member may select the previous page button 72 to alter information on the previous screen, the close button 74 to end the episode or the new episode button 76 to begin the process over with a different consumer.

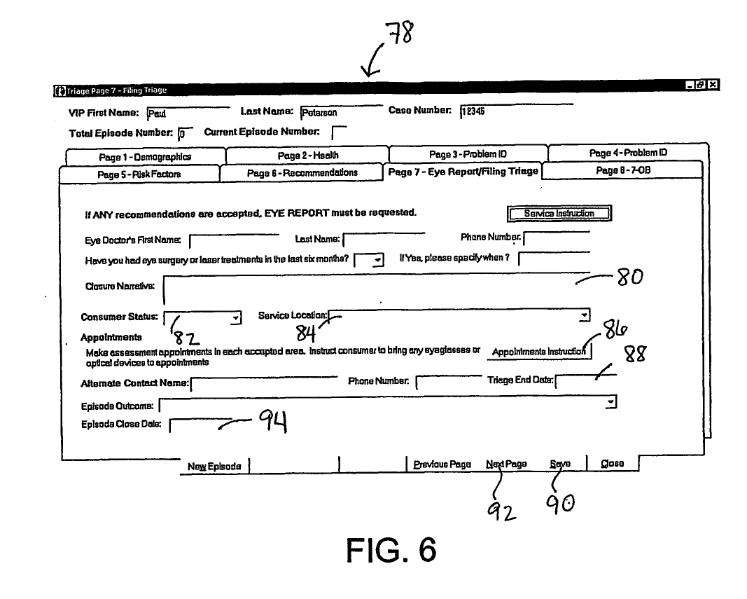

Upon selecting the next page button 70, the closure screen image 78 from the triage process is displayed. See FIG. 6. The closure screen image 78 is the last screen image to be filled out in the triage process and closes out the triage process allowing the consumer's information to be released, only to members of the care team, and the assessment process to begin. Appointments with certified vision rehabilitation professionals are then scheduled. An assessment consists of informational, consumer self assessment and provider rated questions. The assessment produces a service plan, goals and accompanying objectives, a level of care and a pre-service score. These metrics are calculated based on the consumer and provider (staff member) response to the following components: consumer self assessment; provider ratings; standardized tests; learning strategies; and additional factors that affect training. (Not every assessment will use all five components) If the consumer accepts any of the recommendations identified in FIG. 5, the consumer must obtain an eye report from an eye doctor. In the closure image screen 78, the staff member is prompted to ask for the name and telephone number of the consumer's eye doctor as well as if and when the consumer has had any eye surgery or laser treatments within the last six months. The staff member records the consumer's answers in the appropriate window in the closure image screen 78. Next, the staff member records the closure narrative 80 which are the notes of the staff member about the contact, the consumer status 82 and the service location 84, i.e., the location of the service provider. After all the information has been recorded, the staff member selects the appointments button 86 to schedule the consumer for assessment appointments in each of the areas the consumer accepted, identified in FIG. 5. The appointment scheduling includes scheduling the appropriate certified vision rehabilitation professional eligible to conduct the assessment, scheduling any equipment needed for the assessment and scheduling any facility/location needed for the assessment.

At this point during the process, the staff member also asks the consumer whether the consumer has sought assistance from the service provider before with a different name and if so, what was the outcome. If the consumer requests additional services, additional recommendations can be added manually at this point during the process. To end the triage process, the staff member must fill in the end triage date 88 in the appropriate window in screen 78. If the consumer has rejected all the interventions or services being offered, the staff member records the episode closure date 94 in the appropriate window. After all the information has been recorded on the closure screen image 78, the staff member selects the save button 90 which then saves all the consumer's information. After saving the information, the staff member selects the next page button 92 at the bottom of the closure screen image 78.

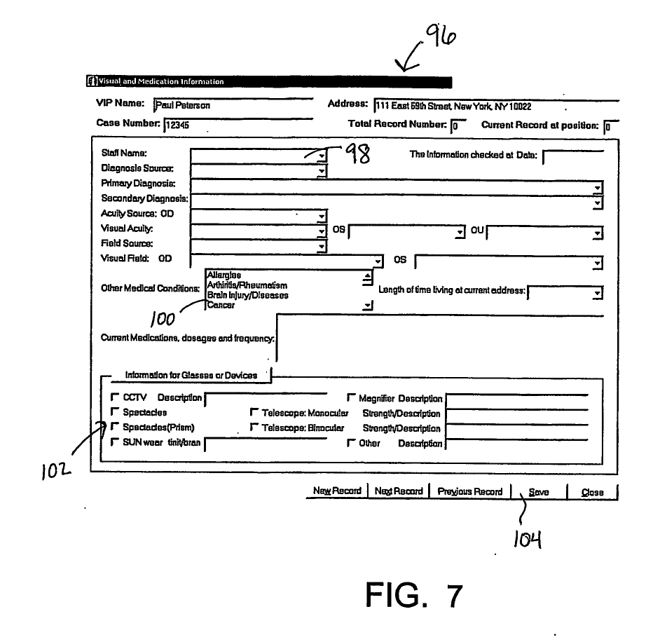

At any time during the processes, visual and health information about the consumer can be entered into the system, however, it is recommended that this information be recorded at the beginning of the episode, during the triage phase. FIG. 7 illustrates a visual and health information screen image 96 in accordance with an exemplary embodiment of the present invention. The visual and health information recorded on this screen image 96 is a valuable resource as the assessment workers utilize this information to perform assessments on the consumer. It is possible for more than one visual and health information record to exist as the consumer can update visual and health information at any time. The assessment worker will be provided with the most current record. In the visual and health information screen image 96, the staff member's name is selected from a window 98 containing a drop down box with all of the names of the-staff members on the care team. The staff member also enters any vision diagnosis the consumer has received as well as any other medical conditions 100 the consumer has, such as allergies, arthritis, cancer, etc., by selecting the appropriate condition from the drop down box. The staff member records any other medical conditions the consumer has. If the consumer is currently taking any medications, these medications are recorded, including the dosages and frequency. Finally, the staff member enters information about the consumer's glasses or any other visual device the consumer uses 102. This information can include spectacles, sunglasses, telescopes, etc. After all the information has been recorded on the visual and health information screen image 96, the staff member selects the save button 104 which then saves all the consumer's visual and health information.

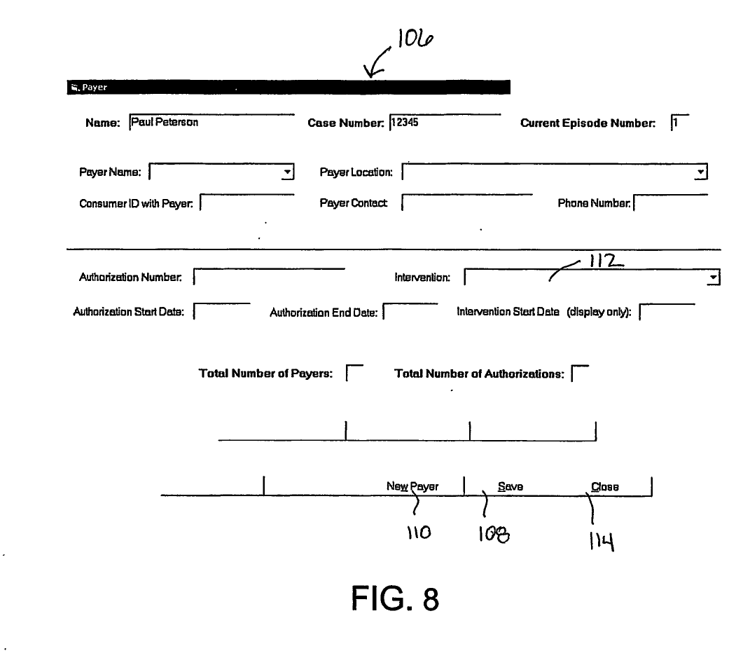

After the triage process, information relating to payment is recorded. FIG. 8 illustrates a payer screen image 106 in accordance with an exemplary embodiment of the present invention. In the payer screen image 106, the staff member enters information as to the method of payment that the consumer will be using to pay for the first intervention, such as an insurance company, Medicare, a grant, etc. This information includes the payer name, location, contact, and phone number. The information is then used to contact the payer to receive authorization for the intervention. Once the payer has provided authorization, the authorization number, the time period for which the authorization is valid and the particular intervention(s) the authorization is valid for, the intervention can begin. After all the information has been recorded on the payer screen image 106, the staff member selects the save button 108 which then saves all the payer's information and authorizations. If interventions do not appear in the drop down box of the intervention window 112, then triage has not been completed. Triage must be completed prior to the authorization stage. If the consumer has more than one payer or more than one intervention, the staff member selects the new payer button 110 to add additional information and authorizations from additional payers. Payer information is stored for each occurrence of an intervention. If additional interventions are added to the consumer's episode during the process, additional payer information can also be added. There may be only one payer with multiple interventions and multiple authorization numbers. Once all the consumer's payer information has been entered, the staff member selects the close button 114.

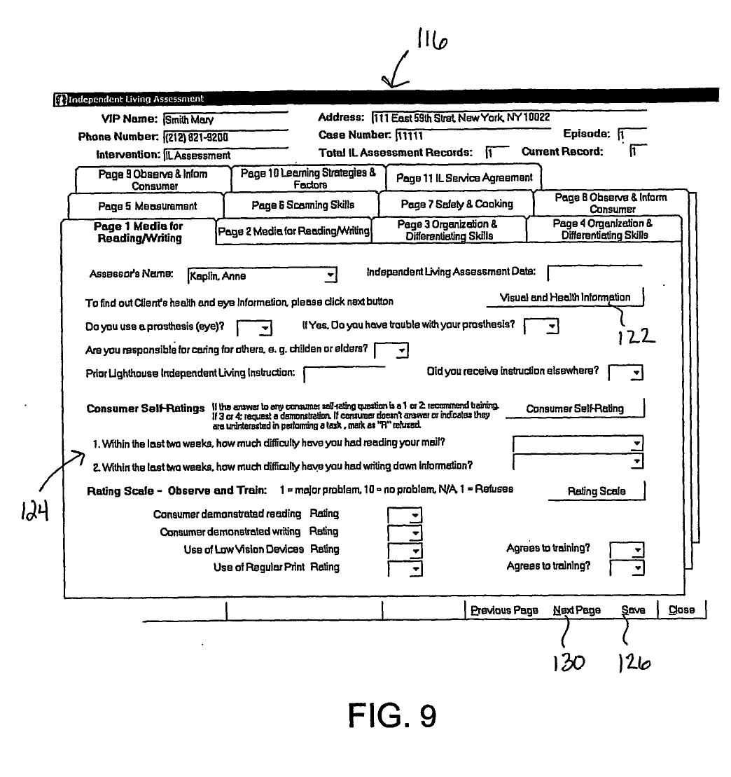

Now that the consumer's visual and health information and payer information have been entered, and the triage process have been completed, the consumer moves on to the intervention and assessment process where the system specifies and limits the certified professionals who can assess and treat in each discipline. FIG. 9 illustrates an independent living assessment screen image 116 in accordance with an exemplary embodiment of the present invention. The independent living assessment is described by way of example only and many other assessments are available to the consumer including psychotherapy, orientation and mobility, social service, low vision, computer training, and employment services. In the assessment screen image 116, there are numerous drop down boxes which do not have to be utilized, but instead data can be entered manually. As can be seen in FIG. 9, the independent living assessment image screen 116 is comprised of a series of tabs, each labeled in alphabetical order. Tabs page 1-10 identify possible domains to be assessed with the consumer and tab page 1 identifies a service agreement which summarizes the agreed upon goals associated with the services to be provided to assist the consumer. The media for the reading/writing portion of the independent living assessment is illustrated in FIG. 9. The assessments are used to evaluate the consumer in the category of service. The assessment visit starts the intervention. As described previously, an assessment consists of informational, consumer self assessment and provider rated required questions. Answers to these questions will trigger goals, objectives and additional services for the consumer. The result of an assessment is to determine a service plan, goals, objectives, a level of care and a pre-service score for the consumer. These metrics are calculated based on the consumer and provider's answers to the following components: consumer self assessment questions, provider ratings, standardized tests, learning strategies and additional factors that affect training. It should be noted that not every assessment will use all five components.

The accepted goals/objectives become the blueprint for training in the intervention. If an assessment results in no training, there will be no incremental record of activity (IRA), the intervention will be closed with an outcome and reason code. An IRA is a record of the findings from the training of the consumer. It numerically captures the progress the consumer is making throughout training. Alternatively, the intervention will be closed at the completion of the final IRA. The blueprint for training will include goals, the projected number of hours that will be required to achieve the goals which is derived from the assessment score, recommendations for other internal or external services and recommended equipment. If the assessor requires the consumer's visual and health information, the assessor selects the visual and health information button 122 which then identifies all records that contain visual and health information about the consumer. The assessor then chooses the appropriate record to view, typically the latest record which will contain the most up to date information about the consumer. The visual and health information screen image, illustrated in FIG. 7, will appear identifying the information about the consumer.

Next, the assessor asks the consumer yet another series of uniform questions to help in the assessment. These questions may include whether or not the consumer has a prosthesis (eye) asked dependent upon vision status and if so, does the consumer have problems with the prosthesis, is the consumer responsible for caring for children or elders, has the consumer received a prior independent living instruction and if the consumer has received instruction elsewhere. The answers to the questions are recorded into the appropriate window in the independent living assessment image screen 116. Next, the assessment determines consumer self-ratings 124. The questions asked to the consumer provide the assessor with the consumer's self-ratings of the consumer's ability in several areas. First, the assessor asks how much difficulty the consumer has had reading mail and writing down information in the last two weeks. Formalized responses by the consumer are then entered into the appropriate windows in the independent living assessment image screen 116. After responding to these questions, the assessor observes the consumer performing certain tasks and enters a score as to the consumer's performance. If the assessor indicates a 1, the consumer is having a major problem. If the assessor indicates a 10, the consumer is not having a problem with that task. These tasks include reading, writing, using low vision devices, use of regular print, personal grooming, cooking, cleaning, and taking care of others.

Goals and objectives are automatically generated by the system based upon the rating and answers to the series of domain questions found in each of the assessments. Scoring is determined by the system based upon the five components identified earlier and the system will calculate a recommended level of service. Before a score can be calculated, the information entered into the independent living assessment image screen 116 must be saved by selecting the save button 126. Once saved, the level of service (duration and intensity) recommended to the consumer will be displayed. The learning strategy and the factors that influence training must be completed by the professional provider before going to the service agreement page. The service agreement page contains goals that have been previously identified. Additional fields are available to record any equipment or other services required. Once completed, dated and saved, the service agreement can be printed. Once completed with the independent living assessment, the assessor selects the next page button 130.

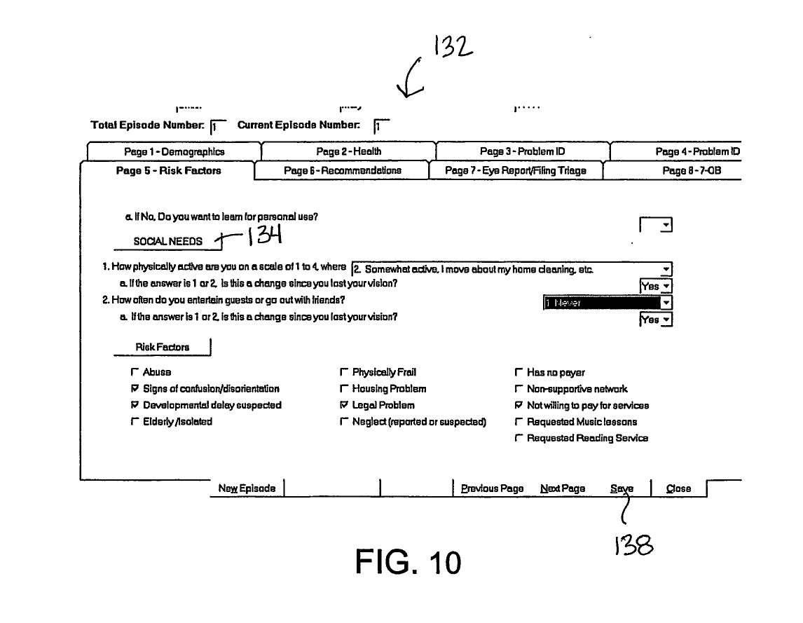

FIG. 10 illustrates a first social service assessment screen image 132 in accordance with an exemplary embodiment of the present invention. Social service is another assessment that can be provided to the consumer. This assessment verifies the social needs and risk factors identified in the triage process. The social service assessment begins with the assessor reviewing key information collected in Registration and Triage identified in the social needs of the consumer screen image 132. The assessor selects the “assess social service(s)” button 134 to have the system determine the primary sections of the social service assessment such as “no support network”, “abuse/neglect”, and “housing issues” that the professional must explore first based on the responses to questions in the Registration (biggest problem) and the Triage (consumer has diabetes?; triggers for social service interaction—abuse, elderly/isolated, etc.) sections. Based upon the answers to the uniform series of questions in each sub-area related to the social needs of consumers with vision impairment, the assessor identifies any needs that are to be addressed Once the series of uniform questions have been asked in the relevant sub-areas, the assessor selects the save button 138 which then saves all the consumer's responses and identified goals. It should be noted that not every assessment will use all five components.

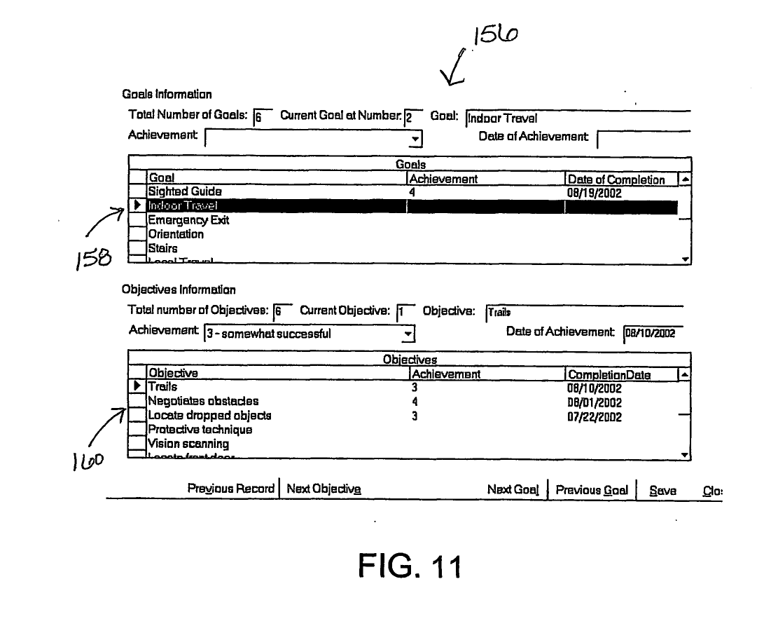

Each assessment performed has a corresponding interim record of activity (IRA) associated with it. All IRAs include a progress report information section, a goal information section and an objective information section. The progress report information section identifies the author of the report, typically the person assigned to provide the service in the intervention, the report period covered and any narrative information. The goal information section identifies the consumer's goal achievements (numerically) and achievement dates as well as a grid view showing the goals. Finally, the objective information section identifies the objectives to be achieved for a goal that is selected. FIG. 11 illustrates the goal information and objective information sections of an interim record of activity screen image 156 in accordance with an exemplary embodiment of the present invention.

Goals are comprised of one or more objectives. An example of the types of goals for consumers are illustrated in FIG. 11. Specifically six goals are identified: sighted guide; indoor travel; ability to use emergency exit; orientation skills; stair usage; and local travel. In the example, the goal of sighted guide has been completed on Aug. 19, 2002 for which the consumer has achieved a rating of 4 and the goal of indoor travel is highlighted in the goals information section 158. As the goal of indoor travel is highlighted, the objectives of the goal of indoor travel are identified in the objective information section 160 of screen image 156. These objectives include trails, negotiating obstacles, locating dropped objects, protective technique, vision scanning and locating the front door. As can be seen in the example of FIG. 11, the goal of indoor travel for mobility is not complete and only 3 of the 6 objectives have been completed. The completed objectives identify the achievement score the consumer has received as well as the date the consumer completed the objective.

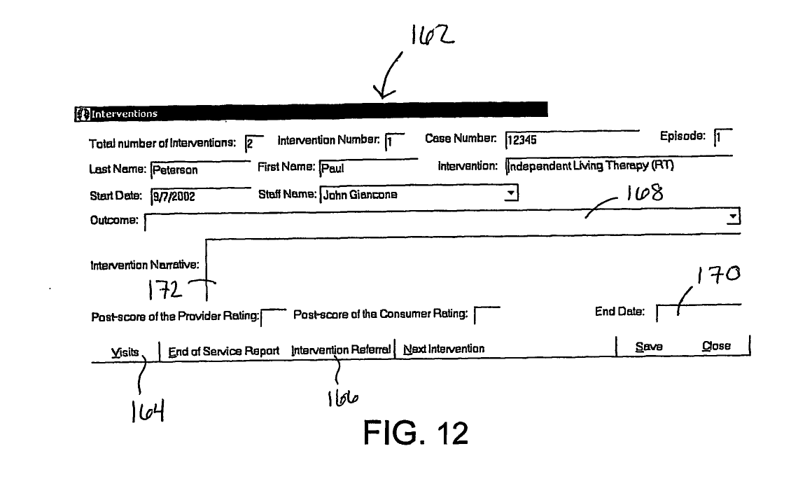

As described previously, interventions are the programs offered to address the problems of the consumers. Interventions are generated during the triage process. Consumers may have multiple interventions; however, only one intervention is shown in a screen image. FIG. 12 illustrates an intervention screen image 162 in accordance with an exemplary embodiment of the present invention. To begin the intervention, the staff member working with the consumer in the intervention selects the visits button 164. Visits are the record of activity for the consumers in the intervention and indicate, among other factors, the date and duration of the visit. If during the intervention, the staff member determines that the consumer requires additional interventions, the staff member selects the intervention referral button 166 and additional interventions can be added to the consumer's record. When an intervention is completed and the related IRAs done, the outcome of the intervention 168 and the ending date 170 of the intervention are entered in the appropriate windows to close the service. Comments from the staff member regarding the intervention are entered into the intervention narrative window 172 as a record of what occurred during the intervention and a post-service score is calculated.

The overall assessment score is determined by scoring and averaging the existing components (up to 5) of the associated assessment: (1) consumer self assessment score; (2) provider rating score (3) standardized test score; (4) learning strategy; and (5) additional factors score. Based upon the intervention and the number of levels associated with that intervention, the system calculates a pre-service score which determines the level of care. The current relationship between the score and level of care is:

1-60=an intensive level of care of 3

61-80=a moderate level of care of 2

81-90=a minimum level of care of 1

91-100=no service needed by the consumer

The level of care is defined by hours of service, frequency of service; and duration of service. For example, a level 3 could indicate 8 hours are needed, a level 2 could indicated that 6 hours are needed, a level 1 could indicate that 2 hours are needed. The system sums the components of the assessment and derives the pre-service functional ability percentage. The recommended level of care is based on the system's calculated pre-functional ability percentage. Values from level of care are drawn from standard level of care values table which can be adjusted based upon future research into the needs of consumers. The system then compares the adjusted level of care to the payer level of care and presents the consumer with the lower of the two levels of care. If the consumer accepts, the level of care hours will be used for calculating remaining hours in the IRAs after visits. For each intervention, the system will display the level of care and hours needed for that service. The level of care is to have an associated time needed to provide the service. The system will display “1 hour per day, 5 days per week over the course of 1 week, for a total of 5 hours”.

As mentioned previously, the consumers are rated or scored in different areas. The scores are determined by summing the consumer self assessment score, the provider ratings score, the standardized tests score, the learning strategies score and the additional factors score and dividing by the number of components. To determine the consumer self assessment score, the consumer raw score is multiplied by a conversion factor and a weighted variable. The consumer raw score is determined by asking the consumer a series of prescribed self assessment questions which the consumer answers on a scale of 1 to 4, R(refused) and NA (not applicable). (R=1 and NA=4). The sum of these values is the consumer self assessment raw score. Each question can be tied to one or more goals and/or to another assessment trigger. Additionally, the ratings or answers to the questions may trigger the goals for the interventions. A rating of 1 or 2 by the consumer will trigger a goal. The consumer's self assessment raw score is multiplied by a conversion factor. The conversion factor changes the score into a 100 point scale. As assessment scores are on the same 100 point scale, the consumer's self; assessment scores can be compared across various areas to determine the consumer's self reported strengths and weaknesses. The scores will then be multiplied by a weighted variable. Weighted variables can be changed. Presently all components are weighted equally, but this can be reevaluated after statistical analysis of the results of the model.

The provider ratings score is the second of 5 possible components that will be used in the calculation of the overall assessment score for a particular intervention. Provider rating questions are rated by the provider and used in calculating the provider raw score. The provider rated questions are rated on a scale of 1 to 10, N/A (not applicable) and N/O (not observable). N/A=10 and N/O=3. If a consumer refuses, the answer is rated as a N/O. A provider rating of 6 or below will trigger the associated goal, objective or additional service. A rating of 1-3 indicates this inability/area has a maximum negative impact on the consumer, a rating of 4-6 indicates a moderate impact, a rating of 7-9 indicates minimal impact and a rating of 10 indicates no impact. The provider raw score is also multiplied by a conversion factor. The conversion factor changes the score into a 100 point scale. The scores will then be multiplied by a weighted variable which determines the provider rating score. Weighted variables can be changed.
(Provider rating score=provider raw score×conversion factor×weighted variable)

Standardized tests are the third, and optional component, of the 5 possible components. Each part of an assessment may or may not exist so that a standardized test is an option for an assessment. The results of the standardized test may determine a goal or objective and also is calculated as one component of the overall score. Generally the lower the score the greater the need for the intervention. If the test uses this standard, then the test section score is determined using the standard formula as the consumer and provider scores, described previously. If the test uses the higher score the greater need for intervention, then the formula is revised as follows: multiply the raw score by 100, divide by the highest possible test score and then subtract the result from 100. Each test has its own rule and that will need to be applied to the general rules so that this will be considered in the general overall scoring of this section. The standardized test score will be multiplied by a weighted variable. If there is more than one standardized test, the converted scores are summed and divided by the number of tests.

Learning strategy, like standardized tests, is an optional component of every assessment. If the system indicates including learning strategy in an assessment, then it is an element that the provider is required to complete. The learning strategy is also the fourth of 5 possible components of the assessment score and is comprised of five choices: visual; visual/tactual/auditory; tactual/auditory; visual/tactual; and tactual. The provider selects the appropriate strategy value for each area. The provider rated values for the learning strategies are as follows:
Visual=100
Visual/tactual/auditory=50
Tactual/auditory=40
Visual/tactual=30
Tactual=10

The learning strategy will be multiplied by a weighted variable. The weighted learning strategy score will be used for the overall assessment calculation.

Additional factors is a-required component of an assessment. These questions are not asked of the consumer. The influence of each factor on the time of the training required is determined by the assessor. The rating scale the provider uses is as follows:

−3=a significant decrease in training

−2=a moderate decrease

−1=a minimal decrease

0=no impact

1=a minimal increase

2=a moderate increase

3=a significant increase

The additional factors score will be multiplied by a weighted variable. The weighted factor score will be used for the overall assessment calculation. Each factor score is first converted to the positive scale and those values are then summed and divided by the number of factors in the particular assessment for the factor score. The following is a conversion table of factor values to positive numeric values:

−3=120

−2=110

−1=105

0=91

1=80

2=60

3=25

Since there is a factor value of 120, the average may result in a value of over 100. If this occurs, 100+ is change to 100.

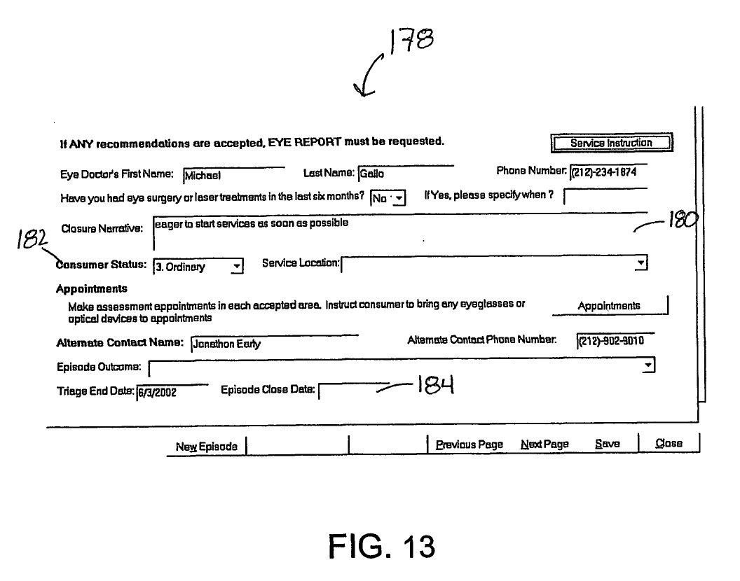

When all interventions have been completed and there is no more service to be given to the consumer, the episode ends. FIG. 13 illustrates ending an episode of service image screen 178 in accordance with an exemplary embodiment of the present invention. To close an episode, the staff member returns to the closure screen image from the triage process illustrated in FIG. 6, and enters the closure narrative 180, the status of the consumer 182 and the closing date of the episode 184. If there are open interventions or incomplete IRAs, an error message will be generated when attempting to enter an episode end date. The episode cannot be completed until the error is corrected by either going into interventions and closing all interventions or completing the IRAs and closing the interventions.

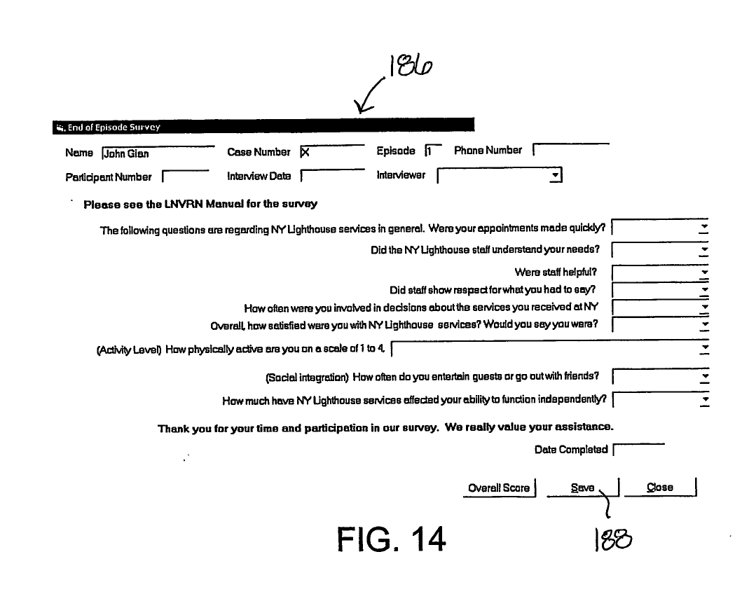

After the consumer's episode has ended, the consumer is interviewed by a third party, not a provider, and the consumer responses recorded for quality assurance purposes. FIG. 14 illustrates a quality assurance screen image 186 in accordance with an exemplary embodiment of the present invention. Once an episode has been closed, random consumers will be asked another series of required questions by a third party to determine the consumer's satisfaction received during the episode. These questions include, but are not limited to:
(1) Were appointments made quickly?
(2) Did the staff understand your needs?
(3) Was the staff helpful?
(4) Did the staff show respect for what you had to say?
(5) How often were you involved in decisions about the services you received?
(6) Overall how satisfied were you with the services?
(7) How physically active are you?
(8) How often do you entertain guests or go out with friends? and
(9) How much have the services affected your ability to function independently?

Once all the questions have been answered, the consumer selects the save button 188.

Six months after completion of all interventions and final IRAs, a post-service follow up is conducted and the quality assurance questionnaire is repeated. Additionally, the post-service follow up also finds out how the consumer has been doing since training has been completed. The answers from these questionnaires are tabulated into quality assurance scores and consumer satisfaction scores. The scores are utilized to provide corrective action, process improvement and to determine if the services provided are still valuable. Finally, the data is collected during the process from consumers, including consumer demographics, intervention types, goals, objectives and the success rate of the interventions. The collected data can then be utilized for such things as cost benefit analysis to determine if the cost of the treatment plans is less than the cost of health care when the consumer has not been treated.

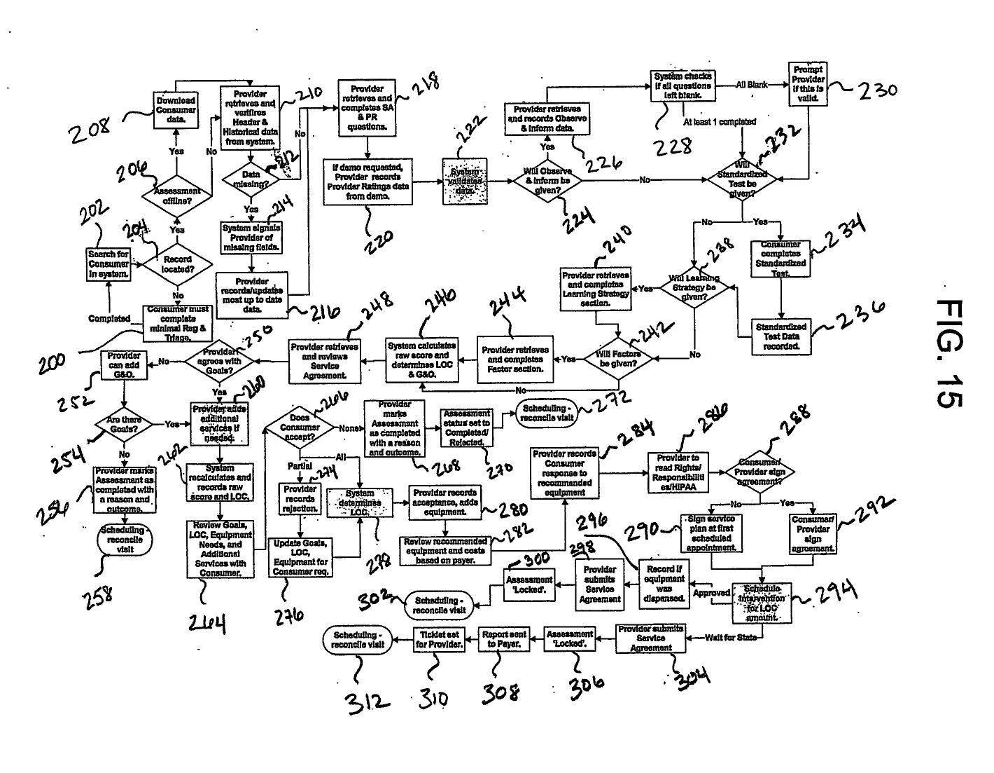

Finally, a flow chart showing the overall method of providing a treatment plan for a consumer through the process of assessment only, as described in greater detail above, is illustrated in FIG. 15. The method begins by the consumer completing minimal requirements of the registration and triage processes 200 and a staff member searching for any episodes that the consumer may have 202. If a current episode has been located, or alternatively, the staff member creates an episode for the consumer 204, the consumer moves into the triage process which leads to the assessment process 206. The assessment can be performed off line by the service provider by downloading the consumer's data 208, or alternatively, the service providers retrieve and verify the consumer's data from the system 210. If any data is missing 212, the system signals the service provider to obtain and record 216 the information from the missing fields 214. Once all possible information has been recorded, the service provider commences the assessment by completing the provider ratings, and asking the consumer a series of uniform self assessment questions 218.

When the consumer is requested to provide a skill demonstration, the service provider records the provider ratings data obtained from the demonstration 220 and the system validates the data 222. The service provider, if applicable to the specific assessment, will share with the consumer any observations 224 of safety or hygienic issues observed during any portion of the assessment (observe and inform) 226. If there is nothing to be observed, this section is skipped. The system checks if any of the self assessment questions have been left blank 228. If any question is left blank, the system will prompt the service provider to determine if this is valid 230.

If a standardized test is given 232 the consumer completes the test 234, the test data is recorded 236, and the service provider moves on to the learning strategy component (if required by the particular assessment 238). Completion of the learning strategy component 240 is required if it is part of any assessment (It should be noted that the psychotherapy assessment does not include learning strategies as they are not relevant for psychotherapy.) The completion of factors 242 influencing intensity of training need is next and once completed, the system calculates the consumer's raw score, pre-service score level of care, and lists the goals and objectives identified based on the responses to the self assessment questions and the service provider ratings 246.

Next, the service provider retrieves and reviews the service agreement with the consumer 248. Upon reviewing the service agreement, the service provider and consumer determine if the goals are appropriate 250. If the goals are not appropriate, additional goals can be added 252. Provider adds additional services if needed 260. Alternatively, if there are no goals 254, and the service provider and consumer agree, the service provider marks the assessment as completed with a reason and outcome 256. The service provider goes to the “visit” screen and reconciles or validates all the information regarding that visit 258. After the service provider and consumer conference and agree on a final set of goals the system recalculates and records the raw score pre-service score and level of care 262 for this particular consumer's needs.

Next, the service provider reviews the equipment needs, and additional internal and external service recommendations with the consumer 264. If the consumer doesn't accept the services 266, the service provider marks the assessment as complete with a reason and outcome 268. If the consumer agrees with the recommendation, a “tickler” is sent to appropriate service providers to complete 270 the recommendations 272. The consumer can decide to accept only some of the recommended goals and objectives. In such a case, the staff member records the goals and objections rejected 274, updates the goals, level of care, and equipment for the consumer that is required 276, and the system calculates the new level of care based upon the partial acceptance of the goals and objectives 278. If the consumer decides to accept all of the goals and objectives, the service provider records the acceptance of the goals and objectives, adds equipment 280 and reviews the recommended equipment and costs based upon what the payer has authorized 282. After reviewing the equipment with the consumer, the service provider records the consumer's response to the equipment needed 284 and reads to the consumer his or her rights and responsibilities and if needed the institution's HIPAA statement 286.

Once a service agreement is agreed upon and signed 292 and authorization for payment has been obtained, the consumer is scheduled for the appropriate number of sessions as determined by the calculated level of care in that intervention 294. (If the consumer does not immediately sign the service agreement 288, it must be signed at the first scheduled appointment 290). The service provider records if any equipment has been dispensed to the consumer 296, and submits the service agreement 298. Upon submitting the service agreement, the assessment is locked 300 and the service provider reconciles the visit 302. The provider submits the service agreement locking the assessment and if a payer has not authorized the service a report is sent to the payer 304. After locking the assessment 306, and if a payer has not authorized the service, a report is sent to the payer 308 and a tickler is set 310 to schedule the intervention only after it has been authorized by the appropriate payer. (Note: If a consumer is in a crises or urgent status, rules are lifted so that immediate service can be started 312)

Although an exemplary embodiment of the invention has been described above by way of example only, it will be understood by those skilled in the field that modifications may be made to the disclosed embodiment without departing from the scope of the invention, which is defined by the appended claims

We claim:

1. A method of generating a treatment plan for a consumer, implementing consistent protocols, the method comprising the steps of:
identifying problems the consumer has by asking a first series of uniform questions related to the consumer's health;
evaluating the major problems of the consumer, to determine the recommended interventions for each of the problems identified, by asking a second series of uniform questions;
generating at least one intervention recommendation based upon the consumer's answers to the second series of uniform questions;
conducting professional assessment(s) to identify recommended treatment for the consumer,
determining an assessment score for the problems identified, by asking a third series of uniform questions; and
recording an incremental record of activity identifying the progress the consumer has made in treating the identified problems.

2. The method of claim 1, wherein the problems are related to vision impairment of the consumer.

3. The method of claim 1, wherein the first series of uniform questions determine if the consumer is in a crisis.

4. The method of claim 1, wherein the first series of uniform questions determine if the consumer is in an urgent situation.

5. The method of claim 1, wherein the at least one intervention recommendations are selected from the group consisting of psychotherapy, adjustment to vision losses, computer training, employment services, help with living independently, social service, help with improving orientation and mobility and help with low or poor vision vision.

6. The method of claim 1, wherein an answer to a question in the second series of uniform questions triggers the at least one intervention recommendations.

7. The method of claim 1, further comprising the step of scheduling an appointment for the consumer for a provider to assess the problems identified by the second series of uniform questions.

8. The method of claim 1, wherein the second series of uniform questions are informational, consumer and provider rated questions.

9. The method of claim 8, wherein the assessment score for each of the identified problems are utilized to determine at least one treatment plan for the consumer to address the consumer's problems and improve function.

10. The method of claim 9, wherein the treatment plan to address the consumer's problems and improve function is a set of goals to achieve in a set time frame

11. The method of claim 10, for the intervention of orientation and mobility, wherein the goals are selected from a group consisting of sighted guide, indoor travel, ability to use emergency exit, orientation skills, stair usage, and local travel.

12. The method of claim 10, further comprising the step of scheduling an appointment to begin the treatment plan.

13. The method of claim 1, wherein the assessment score is the average of the sum of a consumer self assessment score, a provider rating score, a standardize test score, a learning strategy score and an additional factors score converted to a one hundred point scale.

14. The method of claim 13, wherein the assessment score determines a level of care associated with each of the interventions.

15. The method of claim 13, wherein the consumer self assessment score is the sum of the consumer's self ratings to each of the questions in the second and third series of uniform questions;
wherein the provider rating score is the sum of a provider's rating to a series of provider standardized questions;
wherein the standardize test score is the results of standardized tests;
wherein the learning strategy score is the sum of a provider determined value in the learning strategy areas of visual, visual/tactual/auditory tactual/auditory, visual/tactual and tactual; and
wherein the additional factors score is determined by influence of additional factors on the treatment of the problem of the consumer.

16. The method of claim 13, wherein a post assessment score is determined to evaluate the progress of the consumer by comparing the post assessment score with the assessment score.

17. The method of claim 1, wherein the incremental record of activity comprises a progress report section, a goal information section and an objective information section.

18. The method of claim 1, wherein the consumer is asked a final series of quality assurance questions relating to determine the consumer's satisfaction with the outcome of the treatment.

19. The method of claim 18, wherein the answers to the final series of quality assurance questions are utilized to assess the quality of treatment plan.

20. The method of claim 16, wherein data is collected from multiple consumers to produce a cost/benefit analysis to determine if the treatment of consumer's problems reduce health care costs.

21. A method of evaluating the needs of consumers through uniform assessments and analyses, the method comprising the steps of:
identifying a consumer's most serious problem by asking a first series of uniform questions;
initiating a triage process by asking a second series of uniform questions;
generating at least one intervention recommendation based upon the consumer's answers to the second uniform questions;
scheduling appointments for the consumer to assess the severity of the consumer's problems to determine a treatment plan to complete the at least one intervention recommendation;
conducting professional assessment(s) to identify recommended treatment for the consumer;
determining an assessment score for the problems identified, by asking a third series of questions; and
generating an incremental record of activity recording the progress the consumer has made during the appointments.

22. The method of claim 21, further comprising the step of assessing the quality assurance of the at least one interventions by asking the consumer a series of final uniform questions relating to the progress and satisfaction of the consumer.

23. The method claim 21, wherein the consumer is visually impaired.

24. A method of evaluating the needs of consumers through uniform assessments and analyses, the method comprising the steps of:
registering a consumer by asking a first uniform series of questions;
identifying a consumer's most serious problem from the consumer's answers to the first series of uniform questions;
identifying if the consumer is in a crisis from the consumer's answers to the first series of uniform questions;
identifying if the consumer is in an urgent situation from the consumer's answers to the first series of uniform questions;
initiating a triage process by asking a second series of uniform questions;
generating at least one intervention recommendation based upon the consumer's answers to the second uniform questions;
conducting professional assessment(s) to identify recommended treatment for the consumer;
determining an assessment score for the problems identified, by asking a third series of questions;
scheduling appointments for the consumer to assess the severity of the consumer's problems to determine a treatment plan to complete the at least one intervention recommendation;
generating an incremental record of activity recording the progress the consumer has made during the appointments; and
asking the consumer a final series of quality assurance questions relating to determine the consumer's satisfaction with the outcome of the treatment plan.
